(19) United States
(12) Patent Application Publication
(10) Pub. No.: US 2023/0412447 A1
(43) Pub. Date: Dec. 21, 2023

(54) SYSTEMS AND METHODS FOR IMPROVING DEMODULATION REFERENCE SIGNAL CHANNEL ESTIMATION

(71) Applicant: Meta Platforms Technologies, LLC, Menlo Park, CA (US)

(72) Inventors: Weizhong Chen, Georgetown, TX (US); Krishna Srikanth Gomadam, San Jose, CA (US); Djordje Tujkovic, Los Altos, CA (US)

(21) Appl. No.: 18/194,341

(22) Filed: Mar. 31, 2023

Related U.S. Application Data
(60) Provisional application No. 63/326,233, filed on Mar. 31, 2022.

(51) Int. Cl. H04L 27/26; H04L 27/14

(52) U.S. Cl. CPC H04L 27/2695; H04L 27/2665; H04L 27/14

(57) ABSTRACT

A disclosed computer-implemented method may include receiving, as part of a demodulation reference signal (DMRS) channel estimation operation, a frequency domain channel estimation signal comprising a plurality of DMRS samples, and generating an extended channel estimation signal by: (A) determining an extended DMRS sample that extends at least one edge of the channel estimation signal based on: (i) an edge DMRS sample included in the plurality of DMRS samples at the edge of the channel estimation signal, and (ii) at least one additional DMRS sample included in the plurality of DMRS samples, and (B) extending the edge of the channel estimation signal by including the DMRS samples and the extended DMRS sample in the extended channel estimation signal. The method may also include generating an augmented channel estimation signal by extrapolating a frequency edge for the augmented channel estimation signal. Various other systems and methods are also disclosed.

### CROSS-REFERENCE TO RELATED APPLICATION

This application claims the benefit of U.S. Provisional Patent Application No. 63/326,233, filed Mar. 31, 2022, the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 shows a block diagram of a Multiple-Input, Multiple-Output (MIMO) system that includes an antenna panel that may receive radiations from one or more user equipment devices (UEs).

FIG. 2 shows a flow diagram for an example MIMO processing chain.

FIG. 3 is a block diagram of an example system for improving demodulation reference signal (DMRS) channel estimation.

FIG. 4 is a block diagram of an example implementation of a system for improving DMRS channel estimation.

FIG. 5 is a flow diagram of an example method for improving DMRS channel estimation.

FIG. 6 includes a diagram that illustrates a possible algorithm for right edge extension for large packets.

FIG. 7 includes a diagram that illustrates a possible algorithm for left edge extension for large packets.

FIG. 8 illustrates an additional or alternative edge extension algorithm for large packets that further includes a windowing function.

FIG. 9-11 illustrate possible edge extension algorithms for small packets.

FIG. 12 illustrates an edge extension algorithm for medium-sized packets.

FIG. 13 includes a diagram that illustrates a possible edge extrapolation algorithm in accordance with the DMRS channel estimation and extrapolation architecture described herein.

FIGS. 14 through 18 illustrate additional or alternative example algorithms or methods for further improving DMRS channel estimation in accordance with the DMRS channel estimation and extrapolation architecture disclosed herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

New Radio (NR) is a radio access technology (RAT) developed by the 3rd Generation Partnership Project (3GPP) for the fifth generation (5G) mobile network. In 5G NR, a physical uplink shared channel (PUSCH) is a physical uplink channel that carries user data from a UE device to a base station (BS). A DMRS is a reference signal associated with PUSCH. DMRS is used for channel estimation as part of coherent demodulation of PUSCH. The DMRS, known to both the BS and the UE, is sent by the UE, and is used by the BS receiver to acquire a propagation channel to recover data from each UE.

In some examples, a DMRS channel estimation architecture may include edge extrapolation for least-squares (LS) channel estimation to reduce edge effects. The “edge effect” may be a phenomenon that occurs when a signal is transformed using the fast Fourier transform (FFT) algorithm. An edge effect may occur due to the fact that the FFT assumes that the signal is periodic; any discontinuities or abrupt changes at the boundaries of the signal can cause artifacts in the frequency domain.

In general, for large packets, conventional edge extrapolation techniques may be effective to remove some edge effects. However, the resulting DMRS channel estimation may still be impacted on the edges. The impact of edge effects relative to the overall DMRS channel in a large band may be small because scrambling in the decoding process may spread edge impacts to the entire band. Thus, the net impact of edge effects may be insignificant for large packets.

However, the net impact of the edge effects may grow as the bandwidth (also “BW” herein) becomes smaller. Furthermore, in some examples (e.g., a multiuser environment with different user grouping of different user packet sizes, operating within a multi-core operational environment, etc.) large packets may also generally be broken into multiple resource block (RB) segments. In such examples, algorithm design may call for a smaller segment size without a significant compromise in performance.

For medium packets, such as bandwidths below 20 physical resource blocks (PRB), the net impact of edge effects on link performance becomes significant, especially for high order modulation such as 256 Quadrature Amplitude Modulation (QAM). This may limit the system throughput, especially for highly loaded systems with low latency requirement applications, where the system may be unable to allocate large bandwidth for individual or single users.

For smaller packets, such as only 1 or 2 PRBs in applications of short messaging with low latency, conventional edge extrapolation techniques may simply be ineffective because there might not be enough samples to effectively extrapolate. For example, in DMRS configuration type 1, one PRB may have only three samples of LS channel estimation; whereas, in DMRS configuration type 2, one PRB may have only two samples of LS channel estimation. Hence, the present application identifies and addresses a need for an improved systems and methods for DMRS channel estimation in 5G NR PUSCH that may reduce and/or mitigate edge effects for all packet sizes.

The present application is directed to systems and methods for improving DMRS channel estimation in 5G-NR PUSCH communications. As described in greater detail below, the systems and methods described herein may improve DMRS channel estimation by extending one or more edges of a received frequency-domain channel estimation signal that may include multiple DMRS samples. Embodiments may further extrapolate the one or more extended edges as part of an overall DMRS channel estimation architecture that may include additional FFT and/or inverse FFT (IFFT) operations, DMRS measurements, windowing operations, frequency interpolation operations, and so forth. Moreover, the systems and methods for edge extension described herein may, in some embodiments, be unique and distinct from conventional repetition of edge DMRS. Additional techniques are disclosed that may address all packet sizes (e.g., small packets of 1-2 RB, medium sized packets of up to twenty-five RB, large sized packets of greater than 25 RB, and so forth). In some examples of large packet sizes, edge extension may be skipped, with only a windowing operation after the edge extension being sufficient. In some examples, the windowing function may be a raised-cosine filter or any other suitable windowing function.

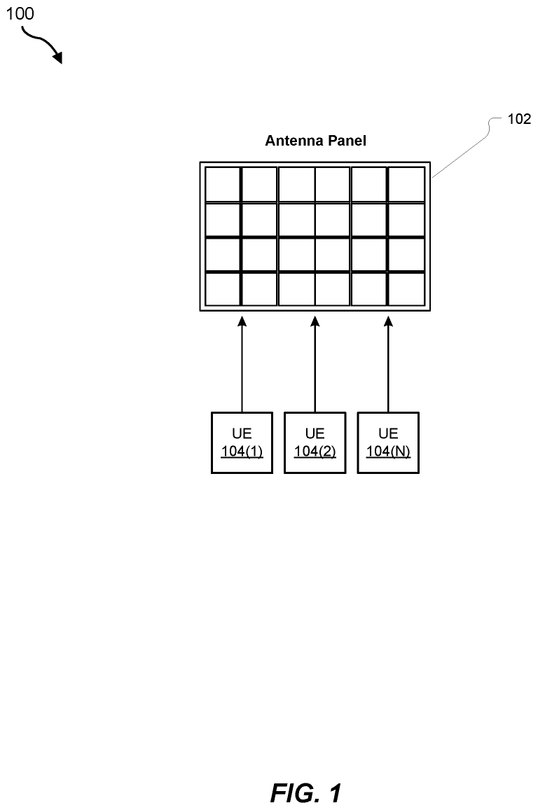

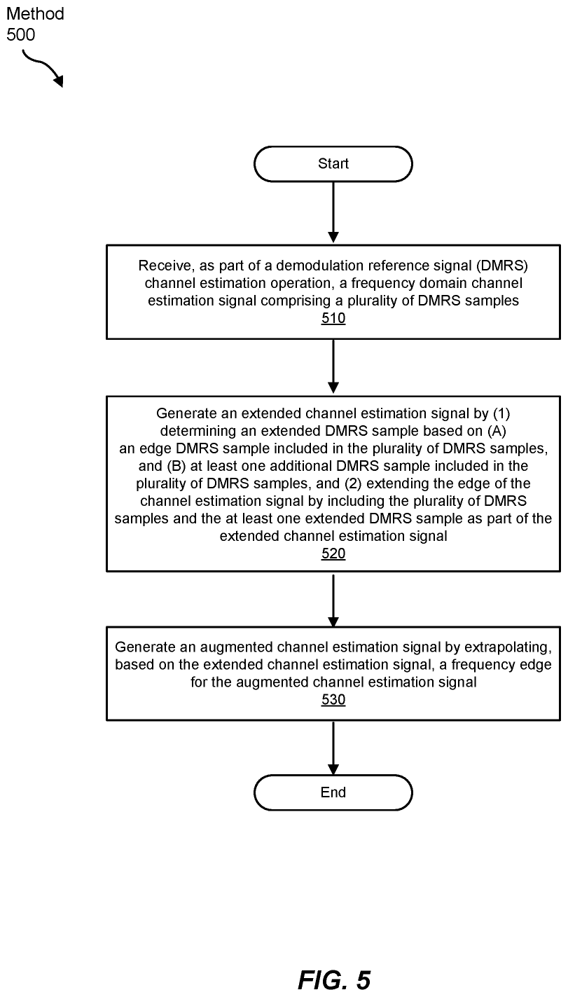

The following will provide, with reference to FIGS. 1-4 and 6-18, detailed descriptions of systems for improving DMRS channel estimation. Detailed descriptions of corresponding computer-implemented methods will also be provided in connection with FIG. 5.

The time-frequency structure of DMRS depends on the type of waveform configured for PUSCH, as defined in 3rd Generation Partnership Project; Technical Specification Group Radio Access Network (TS) 38.211 “NR; Physical channels and modulation,” §§ 6.4.1.1 and 6.4.1.2. The basic transmission scheme in LTE is orthogonal frequency-division multiplexing (OFDM). NR supports a flexible OFDM numerology with subcarrier spacings ranging from 15 kHz up to 240 kHz with a proportional change in cyclic prefix (CP) duration.

In general, an uplink (UL) RB is the smallest resource allocation unit, which is 12 resource elements (RE) in the frequency domain and up to 14 symbols per slot. The frequency separation between REs may be referred to as sub-carrier spacing (SCS). As mentioned above, SCS may be 15×2^{μ} KHz, such that μ=0, 1, 2, 3, 4, resulting in SCS values of 15 KHz, 30 KHz, 60 KHz, 120 KHz, and 240 KHz, respectively. A symbol duration Tₛ may be related to SCS by

$${T}_{s} = \frac{1}{SCS} .$$

Each symbol has a cyclic prefix (CP) with a duration related to SCS or μ.

DMRS signals are partitioned into code division multiplexing (CDM) groups. Within CDM groups, ports are coded with an orthogonal cover code (OCC). DMRS has different configurations: configuration type 1 includes 2 CDM groups for OCC, with a frequency density of 3 DMRS anchors per RB per port, whereas configuration type 2 includes 3 CDM groups for OCC, with a frequency density of 2 DMRS anchors per RB per port. NR UL supports symbol sharing data and DMRS; configuration type 2 has lower DMRS cost if fewer ports are actually used. REs on unused CDM groups may be used for data, while unused ports within a used CDM may not be used for data. For example, in type 1 single symbol, a maximum of 4 ports are supported. If only port 2/3 is used, the DMRS position for port 0/1 can be used for data. Furthermore, discrete Fourier transform (DFT) spread coded OFDM (DFT-s-OFDM) (e.g., for data) is only defined for DMRS configuration type 1.

In general, massive MIMO systems use one or more antenna panels to receive radiations from multiple UEs, each sending a signal over the same radio resources. Data from a UE can be sent with one or more antenna ports. Each UE is allocated one or more unique antenna ports by a BS. FIG. 1 shows a block diagram of a MIMO system 100 that includes an antenna panel 102 that may receive radiations from one or more UE 104 (e.g., UE 104(1), UE 104(2), UE 104(N)). Note that although FIG. 1 shows three UEs, this is provided by way of example only and a MIMO system 100 may include any suitable number of UE devices.

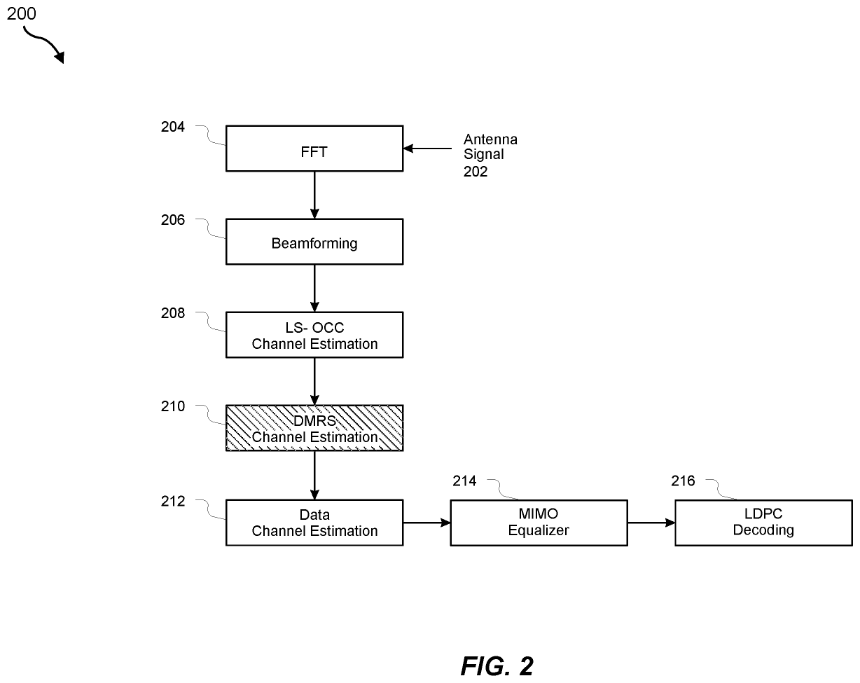

FIG. 2 shows a flow diagram for an example MIMO processing chain 200. As shown, the example massive MIMO processing chain 200 may include operations of receiving of an antenna signal 202, a fast Fourier transform (FFT) operation 204, a beamforming operation 206, an LS OCC channel estimation operation 208, a DMRS channel estimation operation 210, a data channel estimation operation 212, a MIMO equalizer operation 214, and a low-density parity check code (LDPC) decoding operation 216. In general, the systems and methods disclosed herein relate to the DMRS channel estimation operation 210.

In some examples, a DMRS channel estimation architecture may include edge extrapolation for LS channel estimation to reduce edge effects that may be introduced by an IFFT. The IFFT may be implemented to convert the channel estimation signal from the frequency domain to the time domain and to further apply noise reduction. In some examples, an additional windowing operation may be applied after the IFFT to reduce noise on the channel estimation signal. Likewise, a zero-insertion operation may be performed to interpolate the noise-reduced channel estimation signal in the frequency domain from a density of ¼ or ⅙ to a density of 1. An FFT may then be performed to bring the noise-reduced channel estimation signal back to the frequency domain.

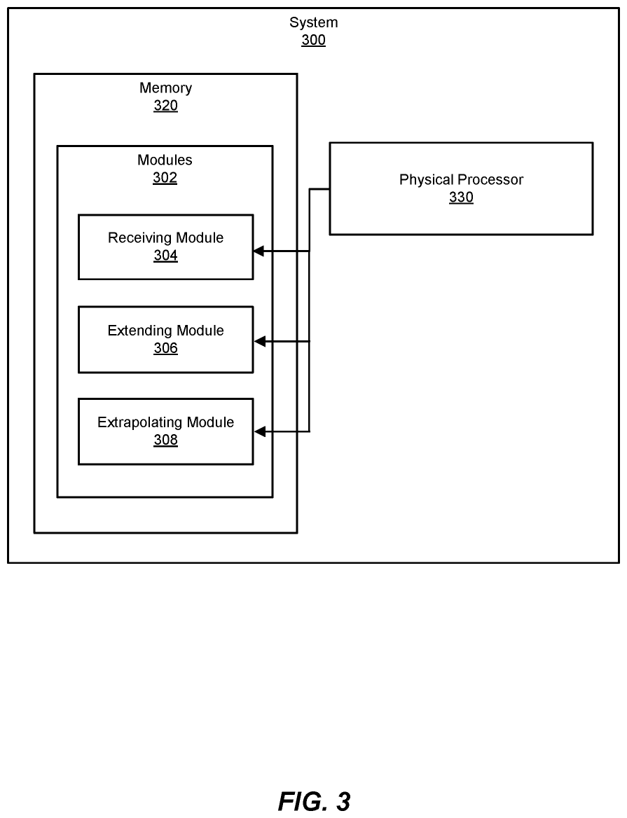

FIG. 3 is a block diagram of an example system 300 for improving DMRS channel estimation. As illustrated in this figure, example system 300 may include one or more modules 302 for performing one or more tasks. As will be explained in greater detail below, modules 302 may include a receiving module 304 that receives, as part of a DMRS channel estimation operation, a DMRS comprising a plurality of DMRS samples.

Example system 300 may also include an extending module 306 that generates an extended channel estimation signal. In some examples, extending module 306 may generate the extended channel estimation signal by (1) determining at least one extended DMRS sample that extends at least one edge of the channel estimation signal based on (A) an edge DMRS sample included in the plurality of DMRS samples at the edge of the channel estimation signal, and (B) at least one additional DMRS sample included in the plurality of DMRS samples. Extending module 306 may further generate the extended channel estimation signal by extending the edge of the channel estimation signal by including the plurality of DMRS samples and the at least one extended DMRS sample as part of the extended channel estimation signal. As further illustrated in FIG. 3, example system 300 may also include an extrapolating module 308 that generates an augmented channel estimation signal by extrapolating, based on the extended channel estimation signal, a frequency edge for the augmented channel estimation signal.

As also illustrated in FIG. 3, example system 300 may also include one or more memory devices, such as memory 320. Memory 320 generally represents any type or form of volatile or non-volatile storage device or medium capable of storing data and/or computer-readable instructions. In one example, memory 320 may store, load, and/or maintain one or more of modules 302. Examples of memory 320 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 3, example system 300 may also include one or more physical processors, such as physical processor 330. Physical processor 330 generally represents any type or form of hardware-implemented processing unit capable of interpreting and/or executing computer-readable instructions. In one example, physical processor 330 may access and/or modify one or more of modules 302 stored in memory 320. Additionally or alternatively, physical processor 330 may execute one or more of modules 302 to facilitate improving of DMRS channel estimation. Examples of physical processor 330 include, without limitation, microprocessors, microcontrollers, central processing units (CPUs), Field-Programmable Gate Arrays (FPGAs) that implement softcore processors, Application-Specific Integrated Circuits (ASICs), digital signal processors (DSPs), portions of one or more of the same, variations or combinations of one or more of the same, or any other suitable physical processor.

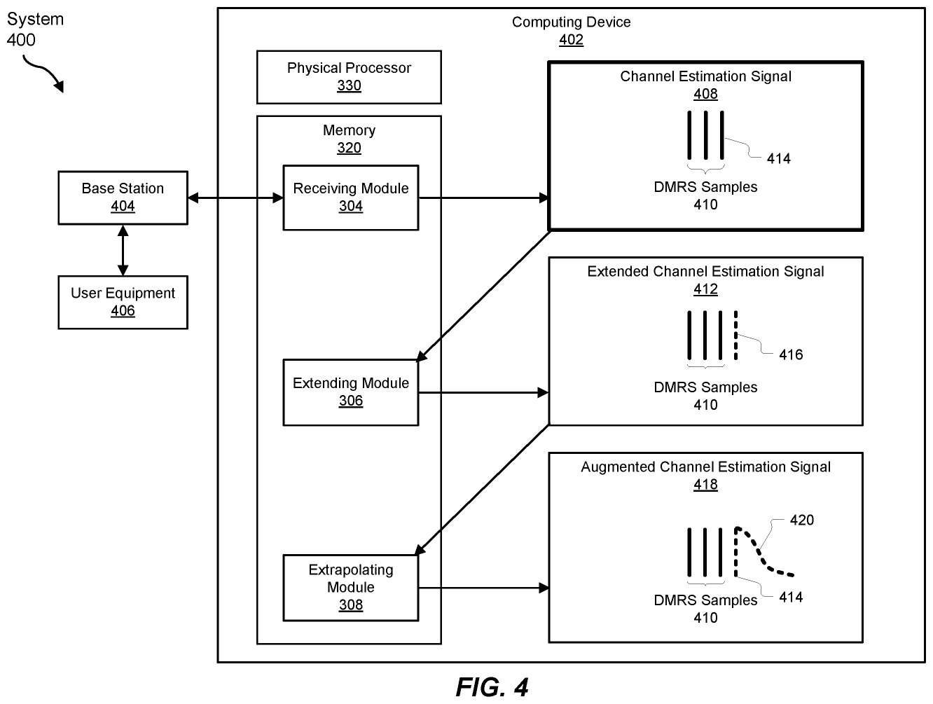

Example system 300 in FIG. 3 may be implemented in a variety of ways. For example, all or a portion of example system 300 may represent portions of an example system 400 (“system 400”) in FIG. 4. As shown in FIG. 4, system 400 may include computing device 402 in communication with a base station 404. Base station 404 may further be in communication with a user equipment 406. In at least one example, computing device 402 may be programmed with one or more of modules 302.

In at least one embodiment, one or more of modules 302 from FIG. 3 may, when executed by computing device 402, enable computing device 402 to perform one or more operations to improve DMRS channel estimation. For example, as will be described in greater detail below, receiving module 304 may cause computing device 402 to receive, as part of a DMRS channel estimation operation, a frequency domain channel estimation signal (e.g., channel estimation signal 408) that includes a plurality of DMRS samples (e.g., DMRS samples 410).

Additionally, extending module 306 may cause computing device 402 to generate an extended channel estimation signal (e.g., extended channel estimation signal 412). For example, in some embodiments, extending module 306 may cause computing device 402 to generate the extended channel estimation signal by determining at least one extended DMRS sample (e.g., extended channel estimation signal 412) that extends at least one edge of the channel estimation signal based on an edge DMRS sample (e.g., edge DMRS sample 414) included in the plurality of DMRS samples at the edge of the channel estimation signal and at least one additional DMRS sample included in the plurality of DMRS samples (e.g., at least one of DMRS samples 410 excluding edge DMRS sample 414). Furthermore, extending module 306 may cause computing device 402 to further generate the extended channel estimation signal by extending the edge of the channel estimation signal by including the plurality of DMRS samples and the at least one extended DMRS sample as part of the extended channel estimation signal.

Moreover, as will be described in greater detail below, extrapolating module 308 may cause computing device 402 to generate an augmented channel estimation signal (e.g., augmented channel estimation signal 418) by extrapolating, based on the extended channel estimation signal, a frequency edge (e.g., frequency edge 420) for the augmented channel estimation signal.

Computing device 402 generally represents any type or form of computing device capable of reading and/or executing computer-executable instructions and/or hosting executables. Examples of computing device 402 include, without limitation, application servers, storage servers, database servers, web servers, signal processing devices, and/or any other suitable computing device configured to run certain software applications and/or provide various application, storage, and/or signal processing services.

In at least one example, computing device 402 may be a computing device programmed with one or more of modules 302. All or a portion of the functionality of modules 302 may be performed by computing device 402 and/or any other suitable computing system. As will be described in greater detail below, one or more of modules 302 from FIG. 3 may, when executed by at least one processor of computing device 402, enable computing device 402 to improve DMRS channel estimation by reducing edge effects for one or more signals used for a DMRS channel estimation process.

Base station 404 may generally represent an element within a wireless communication system (e.g., system 400) that provides radio coverage and connectivity to user equipment (e.g., user equipment 406) within a specific area or cell. A 5G base station may also be referred to as a gNodeB (gNB). Base station 404 may include a variety of components including, without limitation, an antenna array, a transceiver unit, and one or more baseband processing units. The antenna array may be used to transmit and receive radio signals, while the transceiver unit may be responsible for processing the signals and converting them to digital data that can be sent to the baseband processing units. The baseband processing units may be responsible for performing signal processing, error correction, and modulation and demodulation of the signals. Although not so illustrated in FIG. 4, in some examples, computing device 402 may be included as part of base station 404 and/or may be in communication with one or more components of base station 404.

User equipment 406 may include any mobile device or endpoint that connects to a 5G network to access various services, such as voice, video, and data communication. user equipment 406 can be a smartphone, tablet, laptop, or any other wireless device that is designed to operate with 5G networks. In some examples, user equipment 406 may include a 5G modem, one or more antennas, and/or any other suitable hardware that may facilitate communication with base station 404.

Many other devices or subsystems may be connected to system 300 in FIG. 3 and/or system 400 in FIG. 4. Conversely, all of the components and devices illustrated in FIGS. 3 and 4 need not be present to practice the embodiments described and/or illustrated herein. The devices and subsystems referenced above may also be interconnected in different ways from those shown in FIG. 4. Systems 300 and 400 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 5 is a flow diagram of an example computer-implemented method 500 for allocating shared resources in multi-tenant environments. The steps shown in FIG. 5 may be performed by any suitable computer-executable code and/or computing system, including system 300 in FIG. 3, system 400 in FIG. 4, and/or variations or combinations of one or more of the same. In one example, each of the steps shown in FIG. 5 may represent an algorithm whose structure includes and/or is represented by multiple sub-steps, examples of which will be provided in greater detail below.

As illustrated in FIG. 5, at step 510, one or more of the systems described herein may receive, as part of a DMRS channel estimation operation, a frequency domain channel estimation signal that includes a plurality of DMRS samples. For example, receiving module 304 may, as part of computing device 402, cause computing device 402 to receive channel estimation signal 408 that includes DMRS samples 410.

Receiving module 304 may cause computing device 402 to receive channel estimation signal 408 in a variety of contexts. For example, user equipment 406 may seek to establish an uplink with base station 404. User equipment 406 may send a DMRS to base station 404 as part of the uplink transmission. As mentioned above, the DMRS contains a specific pattern of bits that may allow base station 404 to identify and extract the signal from the received waveform. The DMRS may help to mitigate the effects of interference and noise in the wireless channel and improve the reliability and performance of the communication system.

As mentioned above in reference to FIG. 2, a base station (e.g., base station 404) may perform one or more processes on a received antenna signal (e.g., antenna signal 202) prior to a DMRS channel estimation operation (e.g., DMRS channel estimation operation 210). For example, as shown in FIG. 2, a base station may perform an FFT operation (e.g., FFT operation 204), a beamforming operation (e.g., beamforming operation 206), and an LS OCC channel estimation operation (e.g., LS OCC channel estimation operation 208) prior to passing a frequency domain channel estimation signal that includes a plurality of DMRS samples (e.g., channel estimation signal 408 that includes DMRS samples 410) as input to a DMRS channel estimation operation (e.g., DMRS channel estimation operation 210). LS OCC channel estimation operation 208 is to obtain a raw channel estimation signal for each pair of port(s) and antenna(s). Once LS OCC channel estimation operation 208 obtains the raw channel estimation signal, the raw channel estimation signal is passed to the DMRS channel estimation operation 210 to further process the raw channel estimation signal to improve the accuracy and reliability of data demodulation in the uplink transmission.

Hence, receiving module 304 may cause computing device 402 to receive channel estimation signal 408 from one or more components of base station 404.

Returning to FIG. 5, at step 520, one or more of the systems described herein may generate an extended channel estimation signal. For example, extending module 306 may, as part of computing device 402, cause computing device 402 to generate extended channel estimation signal 412.

As further shown in FIG. 5, one or more of the systems described herein may generate the extended channel estimation signal by determining at least one extended DMRS sample that extends at least one edge of the channel estimation signal based on (1) an edge DMRS sample included in the plurality of DMRS samples at the edge of the channel estimation signal, and (2) at least one additional DMRS sample included in the plurality of DMRS samples. For example, extending module 306 may cause computing device 402 to generate extended channel estimation signal 412 by determining, based on edge DMRS sample 414 and at least one other DMRS sample included in DMRS samples 410, extended DMRS sample 416.

FIG. 5 also shows that one or more of the systems described herein may generate the extended channel estimation signal by also extending the edge of the channel estimation signal by including the plurality of DMRS samples and the at least one extended DMRS sample as part of the extended channel estimation signal. For example, extending module 306 may cause computing device 402 to generate extended channel estimation signal 412 by extending the edge of channel estimation signal 408 by including DMRS samples 410 and extended DMRS sample 416 in extended channel estimation signal 412.

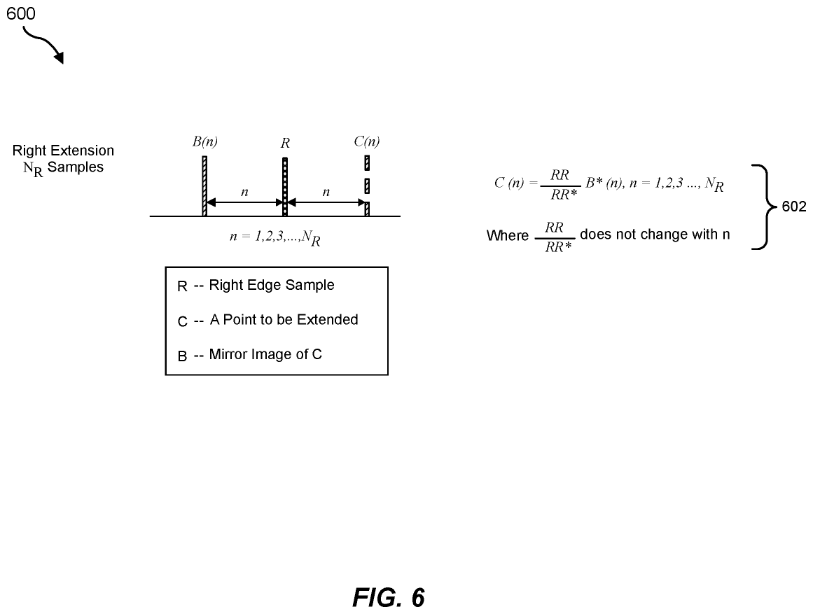

In some examples, extending module 306 may apply different edge extension techniques and/or algorithms depending on a size of a received packet. For example, FIG. 6 includes a diagram 600 that illustrates a possible algorithm for right edge extension for large packets (e.g., packets greater than 25 RB). In this example, extending module 306 may select the additional DMRS sample from the plurality of DMRS samples (e.g., DMRS samples 410) based on a target frequency interval between the extended DMRS sample (e.g., extended DMRS sample 416) and the edge DMRS sample (e.g., edge DMRS sample 414). Extending module 306 may further determine the extended DMRS sample (e.g., a magnitude or phase of the extended DMRS sample) based on a relationship between a magnitude or phase of the extended DMRS sample and a magnitude or phase of the selected additional DMRS sample, such as a normalized spectral density of the edge DMRS sample and a complex conjugate of the selected additional DMRS sample.

In FIG. 6, the illustrated algorithm may extend a right edge by N_{R} samples. As illustrated, R represents a right edge sample (e.g., edge DMRS sample 414) and C represents an extended DMRS sample to be generated (e.g., extended DMRS sample 416) at a target frequency interval n from R. B represents a “mirror image” of C: a sample from the plurality of DMRS samples that is a target frequency interval of n from R. Extending module 306 may determine a value of C(n) based on a normalized power spectral density of R(n) and a complex conjugate of B(n) (e.g.,

$$\frac{RR}{{RR}^{*}} {B}^{*} ( n ) ) ,$$

in accordance with function 602.

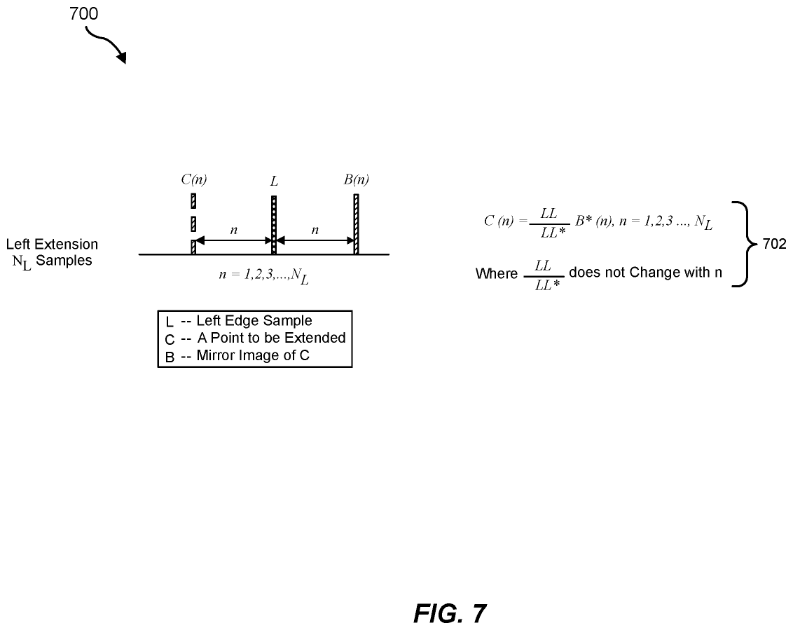

Likewise, FIG. 7 includes a diagram 700 that illustrates a possible algorithm for left edge extension for large packets (e.g., greater than 25 RB) that may extend a left edge by N_{L} samples. As shown, L represents a left edge sample (e.g., edge DMRS sample 414) and C represents an extended DMRS sample to be generated (e.g., extended DMRS sample 416) at a target frequency interval n from L. B represents a “mirror image” of C: a sample from the plurality of DMRS samples that is a target frequency interval of n from L. Extending module 306 may determine a value of C(n) based on a normalized power spectral density of L(n) and a complex conjugate of B(n) (e.g.,

$$\frac{LL}{{LL}^{*}} {B}^{*} ( n ) ) ,$$

in accordance with function 702.

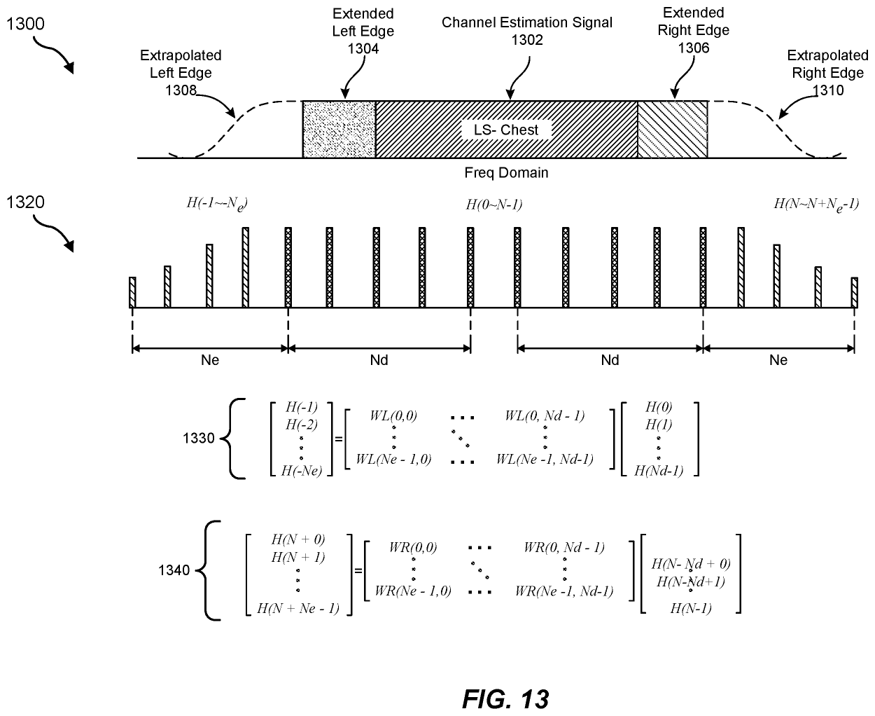

In many cases, N_{L}≤16 and N_{R}≤16, but N_{L}=N_{R} is not required. In cases where N_{L}=N_{R}≥16, a windowing function may be applied to extended N_{R} and N_{L} samples on the right and left edges prior to or as part of an edge extrapolation (e.g., by extrapolating module 308, as will be described in greater detail below in reference to FIG. 13). The windowing function may be a raised-cosine filter or other suitable windowing function (e.g., Hamming window, Blackman window, Kaiser window, etc.) and may be applied to any suitable number of samples (e.g., one sample, two samples, twelve samples, etc.) on each edge. In some examples, this technique may be referred to as “edge taping”.

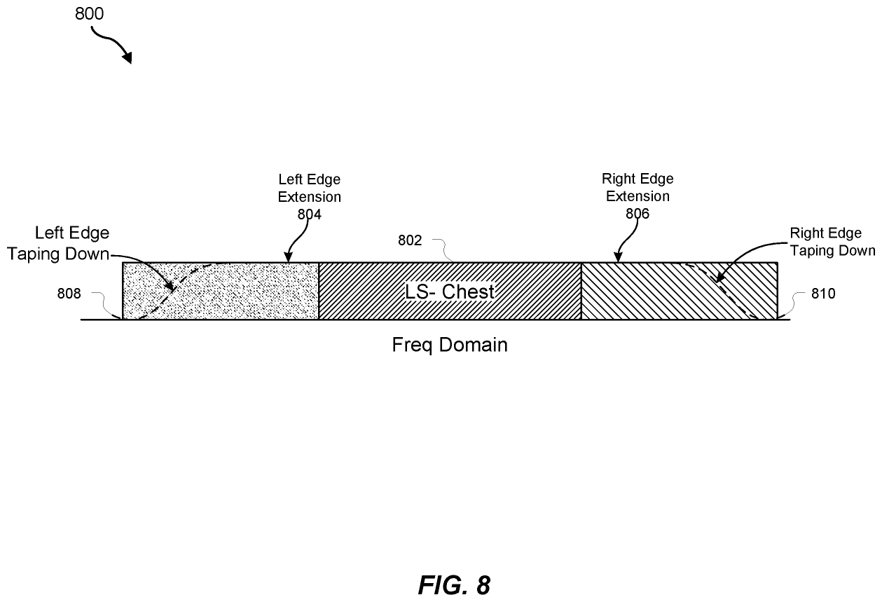

FIG. 8 includes a plot 800 that illustrates an additional or alternative edge extension algorithm for large packets that further includes a windowing function. As shown in FIG. 8, channel estimation signal 802 has been extended by extending module 306, generating left edge extension 804 and right edge extension 806. In this example, one or more of the systems described herein (e.g., receiving module 304, extending module 306, and/or extrapolating module 308) may have applied a windowing function to left edge extension 804 and/or right edge extension 806, “taping down” left edge extrapolation 808 and right edge extrapolation 810.

In some embodiments, the systems and methods described herein may provide edge extension for smaller packets (e.g., packets having a BW of 1 or 2 RB). In such examples, embodiments of the systems and methods described herein (e.g., one or more of modules 302) may perform multiple extensions in multiple iterations. For example, a channel estimation signal may include both a left edge DMRS sample and a right edge DMRS sample, and extending module 306 may generate the extended channel estimation signal (e.g., extended channel estimation signal 412) by determining at least one left edge extended DMRS sample that extends the left edge of the channel estimation signal and by determining at least one right edge extended DMRS sample that extends the right edge of the channel estimation signal (e.g., extended DMRS sample 416). Extending module 306 may further extend the edge of the channel estimation signal by including left edge extended DMRS sample, the plurality of DMRS samples (e.g., DMRS samples 410), and the right edge extended DMRS sample as part of the extended channel estimation signal.

In additional embodiments, extending module 306 may further extend the channel estimation signal by performing an additional extension, using the first extended channel estimation signal as input to an additional extension operation. Extending module 306 may then extend the first extended channel estimation signal by determining at least one extended intermediate left edge DMRS sample that extends the first extended left edge of the first extended channel estimation signal, determining at least one extended intermediate right edge DMRS sample that extends the first extended right edge of the first extended channel estimation signal. Extending module 306 may then extend the edge of the channel estimation signal by including the at least one extended intermediate left edge DMRS sample, the first extended channel estimation signal, and the at least one extended intermediate right edge DMRS sample as part of the extended channel estimation signal.

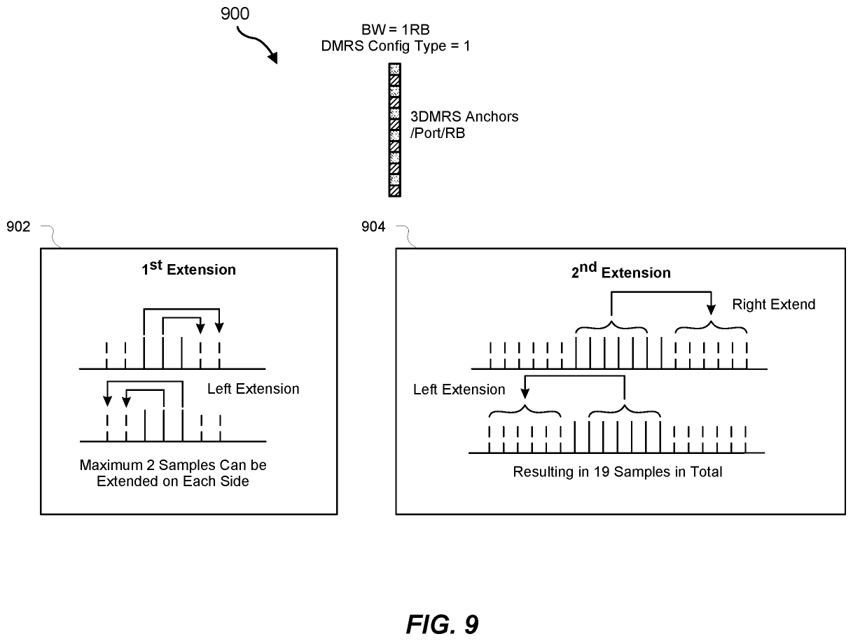

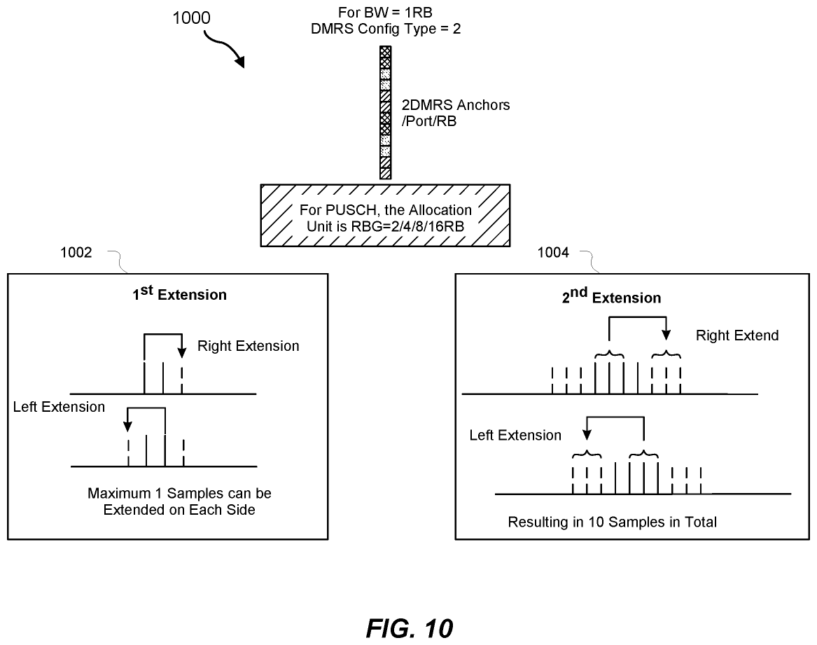

FIG. 9 and FIG. 10 illustrate example edge extension algorithms for packets having a bandwidth of 1 RB. In FIG. 9, diagram 900 illustrates that, for DMRS configuration type 1, there may be three DMRS anchors per port per RB. Diagram 902 shows that a first extension may extend up to two samples on each side. A second extension, as shown in diagram 904, may result in 19 samples in total. Moving to FIG. 10, diagram 1000 illustrates that, in DMRS configuration type 2, there may be two DMRS anchors per port per RB. Diagram 1002 shows that a first extension may extend one sample on each side, and diagram 1004 shows that a second extension may result in 10 samples total.

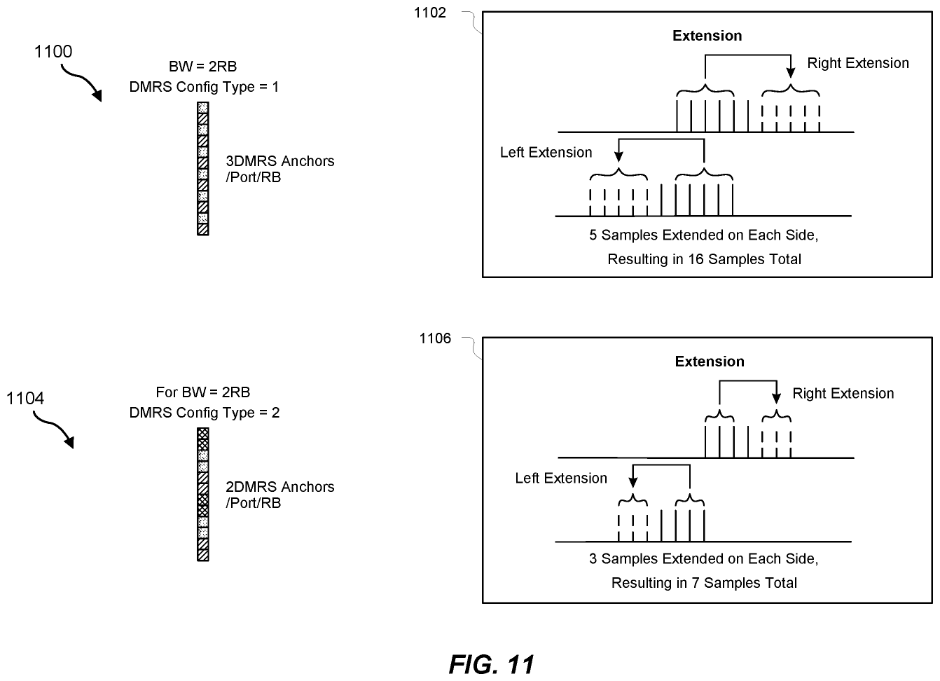

FIG. 11 illustrates an edge extension algorithm for small packets having a BW of two RBs. As shown in diagram 1100, for DMRS configuration type 1, there may be three DMRS anchors per port per RB. Thus, as shown in diagram 1102, five samples may be extended on each side, resulting in 16 samples total. As shown in diagram 1104, there may be two DMRS anchors per port per RB. Thus, as shown in diagram 1106, three samples may be extended on each side, resulting in seven samples total.

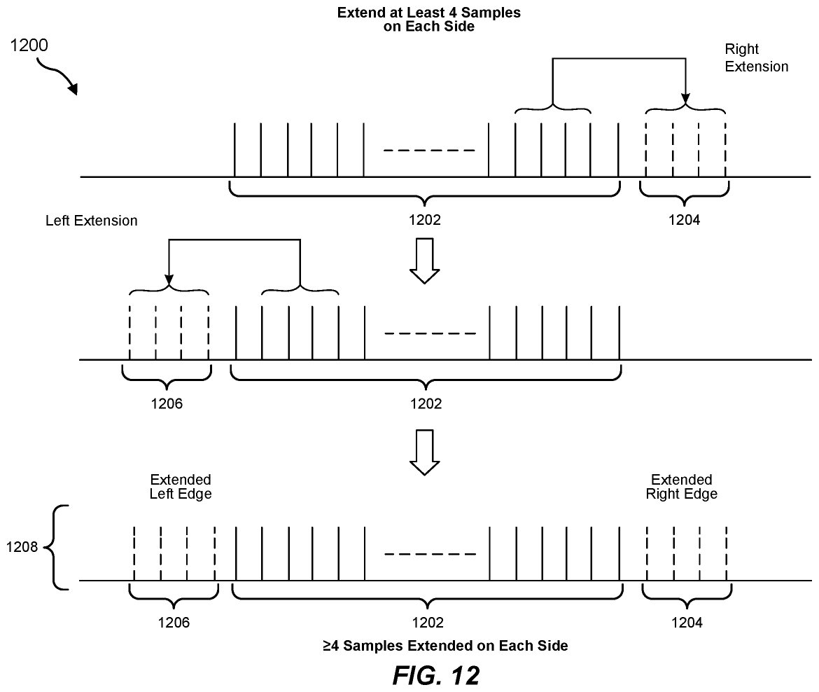

FIG. 12 shows a diagram 1200 that illustrates an edge extension algorithm for medium-sized packets in the range of two RBs up to 25 RBs. In this example, the edges may be extended by at least four samples on each side. As shown, extending module 306 may perform a right extension operation using DMRS samples 1202, generating extended right edge 1204. Extending module 306 may further perform a left extension operation using DMRS samples 1202, generating extended left edge 1206. Extending module 306 may then generate an extended channel estimation signal 1208 by including extended left edge 1206, DMRS samples 1202, and extended right edge 1204 in the extended channel estimation signal.

In summary, extending module 306 may extend the original channel estimation signal (i.e., output from a LS OCC channel estimation process) by determining additional DMRS samples at one or both of the left and right edges. This edge extension may improve channel estimation in 5G NR PUSCH, ultimately enhancing the quality of a received uplink signal.

Returning to FIG. 5, at step 530, one or more of the systems described herein may generate an augmented channel estimation signal by extrapolating, based on the extended channel estimation signal, a frequency edge for the augmented channel estimation signal. For example, extrapolating module 308 may, as part of computing device 402, cause computing device 402 to generate augmented channel estimation signal 418 by extrapolating, based on extended channel estimation signal 412, frequency edge 420 for augmented channel estimation signal 418.

Extrapolating module 308 may extrapolate frequency edge 420 in a variety of contexts. For example, extrapolating module 308 may, as described above in reference to FIG. 8, when a packet size meets a predetermined threshold, apply a windowing function (e.g., a raised cosine window, a Hamming window, a Hann window, etc.) to at least a portion of a plurality of extended DMRS samples prior to or as part of extrapolating a frequency edge for the extended channel estimation signal.

Additionally or alternatively, for smaller or medium sized packets (e.g., packets where BW is less than 25 RBs), extrapolating module 308 may extrapolate frequency edge 420 by applying a precalculated interpolation matrix to the edge of the extended channel estimation signal. By way of illustration, FIG. 13 includes a diagram that illustrates a possible edge extrapolation algorithm. Frequency domain plot 1300 shows an extended channel estimation signal with extrapolated edges. As shown, channel estimation signal 1302 has an extended left edge 1304 and an extended right edge 1306. Extrapolating module 308 may therefore execute a left edge extrapolation operation using channel estimation signal 1302, extended left edge 1304, and/or extended right edge 1306 to generate extrapolated left edge 1308. Similarly, extrapolating module 308 may execute a right edge extrapolation operation using channel estimation signal 1302, extended left edge 1304, and/or extended right edge 1306 to generate extrapolated right edge 1310.

Frequency domain plot 1320 illustrates a frequency domain plot 1320 that describes different portions, bins, or segments of an extended channel estimation signal that may be used to extrapolate a left and a right edge using left matrix operation 1330 and matrix operation 1340, respectively. In some embodiments, interpolation matrices W_{L} and W_{R} may be applied to different portions of a channel to further extend the right and left edges, respectively.

In some examples, the interpolation matrices W_{L} and W_{R} may be pre-determined (e.g., pre-calculated) and may be determined based on Weiner filter theory. A Wiener filter may be used to produce an estimate of a desired or target random process by linear time-invariant (LTI) filtering of an observed noisy process and additive noise, assuming a known stationary signal and noise spectra. A Wiener filter may minimize a mean square error (MSE) between an estimated random process and a desired process.

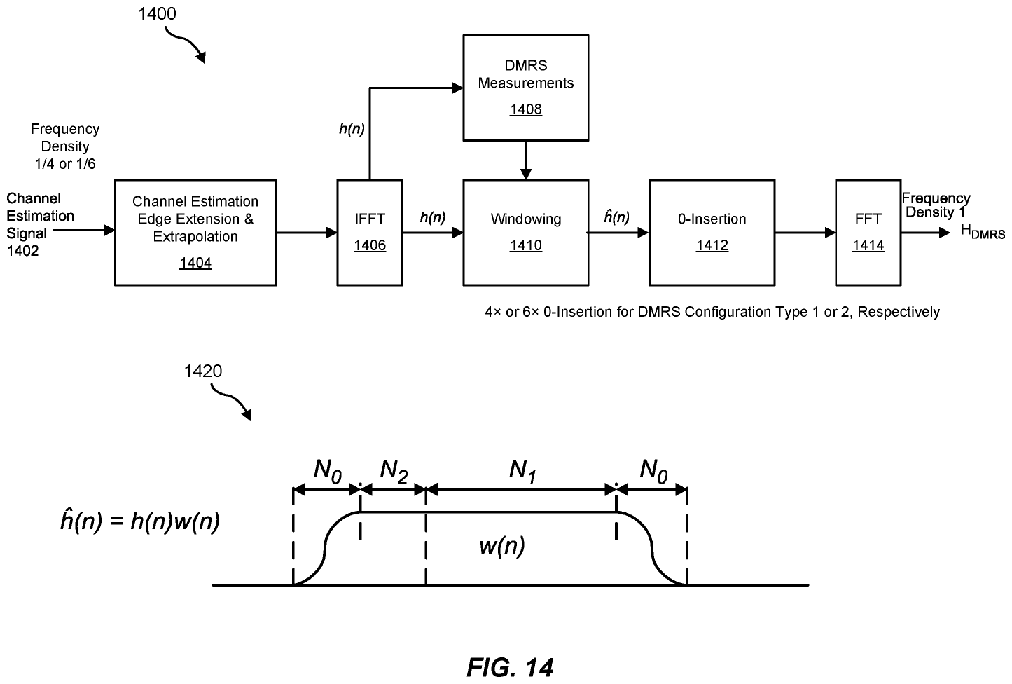

One or more of modules 302 (e.g., one or more of receiving module 304, extending module 306, and/or extrapolating module 308) may perform one or more additional operations to further improve DMRS channel estimation in accordance with the architecture disclosed herein. FIG. 14 includes a block diagram 1400 of possible additional operations that one or more of modules 302 may perform to further improve DMRS channel estimation.

As shown in block diagram 1400, one or more of modules 302 may cause a channel estimation signal 1402 (such as channel estimation signal 408) to undergo a channel extension and extrapolation process 1404. In some examples, the channel extension and extrapolation process 1404 may include or represent any of the operations described above in relation to modules 302, which may result in an augmented channel estimation signal (e.g., augmented channel estimation signal 418). One or more of modules 302 (e.g., extrapolating module 308) may execute an IFFT process 1406, resulting in a time domain representation of the augmented channel estimation signal (e.g., a time-domain representation of augmented channel estimation signal 418), represented in FIG. 14 as h(n).

In some examples, one or more of modules 302 (e.g., extrapolating module 308) may cause the time domain representation of the augmented channel estimation signal (e.g., signal h(n)) to undergo a DMRS measurements process 1408, which may provide parameters N₀, N₁, and N₂. In the example illustrated in FIG. 14, parameter N₀ may define a span of windowing function w(n) having a raised cosine edge with a smooth transition from a zero value to a value represented by the N₂ region on the left of plot 1420 and a smooth transition from a value represented by the N₁ region on the right of plot 1420. Parameter N₂ may define a span of a main lobe of windowing function w(n) and parameter N₁ may define a span of a flat top or plateau region of the windowing function w(n). As further shown in FIG. 14, at windowing process 1410, signal h(n) may be windowed by windowing function w(n) in accordance with h(n)w(n), which may result in noise-reduced windowed signal ĥ(n).

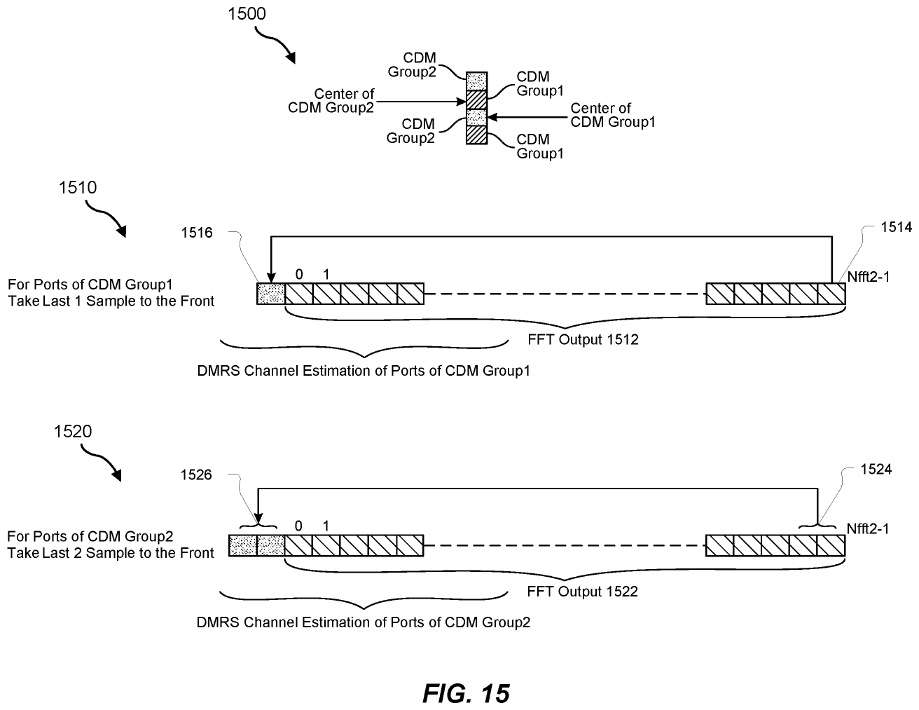

At 0-insertion process 1412, a zero-insertion or zero-padding process inserts zeros between the original samples of the discrete ĥ(n) signal. This zero-insertion process is used to interpolate the noise-reduced DMRS channel to all REs in the frequency-time grid. As will be explained in greater detail below in reference to FIGS. 15-18, channel estimation signal 1402 may have a frequency density of ¼ or ⅙ relative to a frequency density of a desired output signal H_{DMRS}. The zero-insertion process may bring a frequency density of signal ĥ(n) to the desired frequency density (e.g., a frequency density of 1). As shown in FIG. 14, the zero-insertion process may vary depending on a DMRS configuration type, with 4× or 6× zero-insertion for DMRS configuration type 1 or 2, respectively.

At FFT process 1414, the time-domain signal may be converted back to the frequency domain via an additional FFT operation, resulting in frequency-domain signal H_{DMRS}.

After conversion back to the frequency domain, one or more of modules 302 may perform one or more additional operations on a frequency-domain signal (e.g., H_{DMRS}) to further improve DMRS channel estimation. FIGS. 15 through 18 illustrate example algorithms or methods for further improving DMRS channel estimation in accordance with the DMRS channel estimation and extrapolation architecture disclosed herein.

In some examples, the foregoing processes and/or operations may cause samples of a resulting output frequency-domain signal (e.g., H_{DMRS}) to become misaligned with ports of a target CDM group. Hence, one or more of modules 302 (e.g., receiving module 304, extending module 306, and/or extrapolating module 308) may perform one or more operations to ensure proper alignment of the output frequency-domain signal to ports of CDM groups.

FIG. 15 illustrates an algorithm for adjusting an FFT output for ports of CDM groups for DMRS configuration type 1. Diagram 1500 illustrates a misalignment of the last four RBs with CDM group 1 and CDM group 2. Hence, as shown in diagram 1510, when the channel estimation signal corresponds to CDM group 1, one or more of modules 302 may adjust the output frequency-domain signal FFT 1512 (e.g., H_{DMRS}) by moving a far-right end sample 1514 in the output frequency-domain signal to a first position 1516 in a series of samples included in the output frequency domain signal. Alternatively, as shown in diagram 1520, for DMRS configuration type 1, when the channel estimation signal corresponds to CDM group 2, one or more of modules 302 may adjust the output frequency-domain signal FFT 1522 by moving the two samples 1524 from the far-right end of the output frequency-domain signal to the first position 1526 in the series.

For DMRS configuration type 2, ports are separated into three CDM groups. In this scenario, none of the FFT output samples may correspond to a port start, with an offset of ½ of the SCS. To resolve this, one or more of modules 302 may execute a phase rotation of the output frequency-domain signal by

$${e}^{j π \frac{k}{Nfft 2}} ,$$

k=0, 1, 2, . . . , Nifft−1, where Nifft2=6×Nifft1. In this phase rotation process, Nfft2 may represent an expected number of FFT points following an anticipated zero-insertion process. Hence, prior to applying the fast Fourier transform to the noise-reduced time domain representation of the augmented channel estimation signal, one or more of modules 302 may apply a phase rotation to the noise-reduced time-domain signal. By applying a phase rotation, the systems and methods described herein may shift a center of the FFT output to align the frequency-domain DMRS channel estimation signal with the ports of different CDM groups.

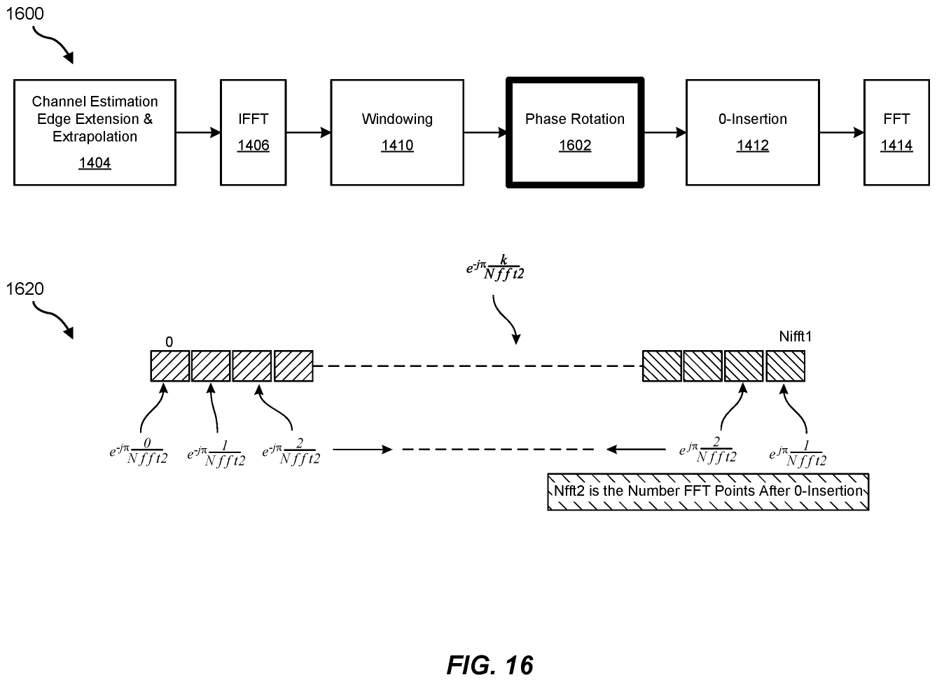

FIG. 16 includes a block diagram 1600 of additional operations that one or more of modules 302 may perform to further improve DMRS channel estimation for DMRS configuration type 2 that includes a phase rotation. As shown, block diagram 1600 includes channel extension and extrapolation process 1404, IFFT process 1406, windowing process 1410, 0-insertion process 1412, and FFT process 1414 from FIG. 14, with phase rotation process 1602 interposed between windowing process 1410 and 0-insertion process 1412. Diagram 1620 further illustrates the foregoing phase rotation process whereby the output frequency-domain signal is adjusted by

$${e}^{j π \frac{k}{Nfft 2}} ,$$

k=0, 1, 2, . . . , Nifft−1, where Nifft2=6×Nifft1 and Nfft2 represents an expected number of FFT points following an anticipated zero-insertion process (e.g., 0-insertion process 1412).

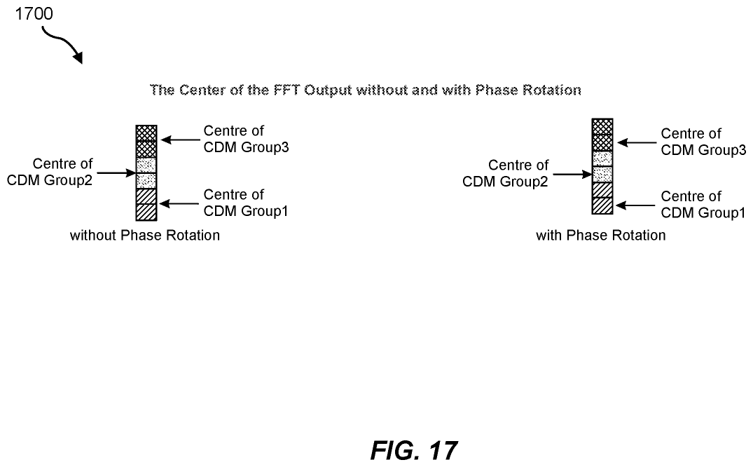

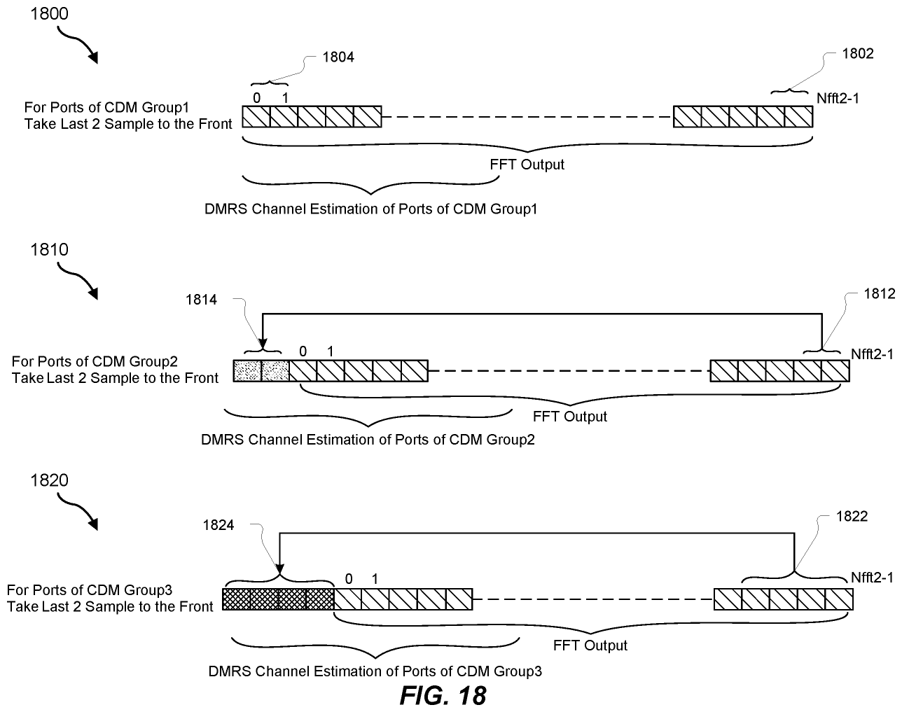

FIGS. 17 and 18 illustrate adjusting an FFT output for ports of CDM groups for DMRS configuration type 2. Diagram 1700 illustrates a misalignment of the last six RBs with CDM group 1, CDM group 2, and CDM group 3. Hence, as shown in diagram 1800 in FIG. 18, when the channel estimation signal corresponds to CDM group 1, one or more of modules 302 may adjust the output frequency-domain signal by moving the two samples 1802 from the far-right end of the output frequency-domain signal to the first position 1804 in the series. Additionally, as shown in diagram 1810, when the channel estimation signal corresponds to CDM group 2, one or more of modules 302 may adjust the output frequency-domain signal by moving the two samples 1812 from the far-right end of the output frequency-domain signal to the first position 1814 in the series. Finally, as shown in diagram 1820, when the channel estimation signal corresponds to CDM group 3, one or more of modules 302 may adjust the output frequency-domain signal by moving the four samples 1822 from the far-right end of the output frequency-domain signal to the first position 1824 in the series.

The systems and methods disclosed herein may have many benefits over conventional options for DMRS channel estimation. For example, by extending one or more edges of a received frequency-domain signal as described above, embodiments of the systems and methods described herein may reduce impacts at edges, and therefore improve DMRS channel estimation for all packet sizes. The systems and methods disclosed herein may have particular benefit for small- and medium-sized packets. Furthermore, the systems and methods described herein may be effective and simple to implement and may improve the functioning of wireless telecommunication systems.

The following example embodiments are also included in this disclosure:

Example 1: A computer-implemented method comprising (1) receiving, as part of a demodulation reference signal (DMRS) channel estimation operation, a frequency domain channel estimation signal comprising a plurality of DMRS samples, (2) generating an extended channel estimation signal by (A) determining at least one extended DMRS sample that extends at least one edge of the channel estimation signal based on (i) an edge DMRS sample included in the plurality of DMRS samples at the edge of the channel estimation signal, (ii) at least one additional DMRS sample included in the plurality of DMRS samples, (B) extending the edge of the channel estimation signal by including the plurality of DMRS samples and the at least one extended DMRS sample as part of the extended channel estimation signal, and (3) generating an augmented channel estimation signal by extrapolating, based on the extended channel estimation signal, a frequency edge for the augmented channel estimation signal.

Example 2: The computer-implemented method of example 1, wherein determining the extended DMRS sample comprises (1) selecting the additional DMRS sample from the plurality of DMRS samples included in the channel estimation signal based on a target frequency interval between the extended DMRS sample and the edge DMRS sample, and (2) determining the extended DMRS sample based on a normalized power spectral density of the edge DMRS sample and a complex conjugate of the additional DMRS sample.

Example 3: The computer-implemented method of any of examples 1-2, wherein (1) the edge of the channel estimation signal comprises a right edge of the channel estimation signal, (2) the edge DMRS sample comprises a right edge DMRS sample, the right edge DMRS sample having a higher frequency than other DMRS samples included in the plurality of DMRS samples, and (3) the additional DMRS sample comprises a DMRS sample included in the plurality of DMRS samples having a lower frequency than the right edge DMRS sample.

Example 4: The computer-implemented method of any of examples 1-3, wherein (1) the edge of the channel estimation signal comprises a left edge of the channel estimation signal, (2) the edge DMRS sample comprises a left edge DMRS sample, the left edge DMRS sample having a lower frequency than other DMRS samples included in the plurality of DMRS samples, and (3) the additional DMRS sample comprises a DMRS sample included in the plurality of DMRS samples having a higher frequency than the left edge DMRS sample.

Example 5: The computer-implemented method of any of examples 1-4, wherein (1) the channel estimation signal corresponds to a data packet including a number of resource blocks that exceed a predetermined threshold number of resource blocks, (2) the at least one extended DMRS sample comprises a plurality of extended DMRS samples, a quantity of extended DMRS samples included in the plurality of extended DMRS samples exceeding a predetermined threshold quantity of DMRS samples, and (3) the computer-implemented method further comprises applying a windowing function to at least a portion of the plurality of extended DMRS samples prior to extrapolating the frequency edge for the augmented channel estimation signal.

Example 6: The computer-implemented method of example 5, wherein at least one of (1) the predetermined threshold number of resource blocks is greater than twenty-five resource blocks, (2) the plurality of extended DMRS samples includes at least sixteen extended DMRS samples, or (3) the windowing function comprises a raised cosine windowing function.

Example 7: The computer-implemented method of any of examples 1-6, wherein (1) the channel estimation signal comprises a left edge DMRS sample and a right edge DMRS sample, (2) generating the extended channel estimation signal further comprises (A) determining the at least one extended DMRS sample that extends the edge of the channel estimation signal by determining at least one left edge extended DMRS sample that extends the left edge of the channel estimation signal, (B) determining at least one right edge extended DMRS sample that extends the right edge of the channel estimation signal, and (3) extending the edge of the channel estimation signal by including the at least one left edge extended DMRS sample, the plurality of DMRS samples, and the at least one right edge extended DMRS sample as part of the extended channel estimation signal.

Example 8: The computer-implemented method of example 7, wherein generating the extended channel estimation signal further comprises (1) designating the at least one left edge extended DMRS sample, the plurality of DMRS samples, and the at least one right edge extended DMRS sample as a first extended channel estimation signal comprising a first extended right edge and a first extended left edge, (2) determining at least one extended intermediate left edge DMRS sample that extends the first extended left edge of the first extended channel estimation signal, (3) determining at least one extended intermediate right edge DMRS sample that extends the first extended right edge of the first extended channel estimation signal, and (4) extending the edge of the channel estimation signal by including the at least one extended intermediate left edge DMRS sample, the first extended channel estimation signal, and the at least one extended intermediate right edge DMRS sample as part of the extended channel estimation signal.

Example 9: The computer-implemented method of any of examples 1-8, wherein extrapolating the frequency edge for the augmented channel estimation signal comprises applying a precalculated interpolation matrix to the edge of the extended channel estimation signal.

Example 10: The computer-implemented method of any of examples 1-9, further comprising generating (1) a time-domain representation of the augmented channel estimation signal by applying an inverse fast Fourier transform to the augmented channel estimation signal, (2) a noise-reduced time domain representation of the augmented channel estimation signal by applying a noise reduction filter to the time-domain representation of the augmented channel estimation signal, and (3) a noise-reduced frequency-domain signal by applying a fast Fourier transform to the noise-reduced time domain representation of the augmented channel estimation signal, the noise-reduced frequency-domain signal comprising a plurality of frequency domain samples in a series of signals having at least one left end sample and at least one right end sample.

Example 11: The computer-implemented method of example 10, wherein (1) the channel estimation operation corresponds to a first DMRS configuration type, (2) the computer-implemented method further comprises at least one of (A) when the channel estimation signal corresponds to a first CDM group, moving the at least one right end sample to a first position in the series that precedes the left end sample, or (B) when the channel estimation signal corresponds to a second CDM group and the at least one right end sample comprises two samples, moving the two samples from the right end of the noise-reduced frequency-domain signal to the first position in the series.

Example 12: The computer-implemented method of example 10, wherein (1) the channel estimation operation corresponds to a second DMRS configuration type, (2) the computer-implemented method further comprises (A) prior to applying the fast Fourier transform to the noise-reduced time domain representation of the augmented channel estimation signal, applying a phase rotation to the noise-reduced time-domain signal, (B) at least one of (i) when the channel estimation signal corresponds to a first CDM group and the at least one right end sample comprises two samples, moving the two samples from a right end of the noise-reduced frequency-domain signal to a first position in the series that precedes the left end sample, (ii) when the channel estimation signal corresponds to a second CDM group and the at least one right end sample comprises two samples, moving the two samples from the right end of the noise-reduced frequency-domain signal to the first position, or (iii) when the channel estimation signal corresponds to a third CDM group and the at least one right end sample comprises four samples, moving the four samples from the right end of the noise-reduced frequency-domain signal to the first position.

Example 13: A system comprising (1) a receiving module, stored in memory, that receives, as part of a DMRS channel estimation operation, a frequency domain channel estimation signal comprising a plurality of DMRS samples, (2) an extending module, stored in memory, that generates an extended channel estimation signal by (A) determining at least one extended DMRS sample that extends at least one edge of the channel estimation signal based on (i) an edge DMRS sample included in the plurality of DMRS samples at the edge of the channel estimation signal, (ii) at least one additional DMRS sample included in the plurality of DMRS samples, (B) extending the edge of the channel estimation signal by including the plurality of DMRS samples and the at least one extended DMRS sample as part of the extended channel estimation signal, (3) an extrapolating module, stored in memory, that generates an augmented channel estimation signal by extrapolating, based on the extended channel estimation signal, a frequency edge for the augmented channel estimation signal, and (4) at least one physical processor that executes the receiving module, the extending module, and the extrapolating module.

Example 14: The system of example 13, wherein the extending module determines the extended DMRS sample by (1) selecting the additional DMRS sample from the plurality of DMRS samples included in the channel estimation signal based on a target frequency interval between the extended DMRS sample and the edge DMRS sample, and (2) determining the extended DMRS sample based on a normalized power spectral density of the edge DMRS sample and a complex conjugate of the additional DMRS sample.

Example 15: The system of any of examples 13-14, wherein (1) the channel estimation signal corresponds to a data packet including a number of resource blocks that exceed a predetermined threshold number of resource blocks, (2) the at least one extended DMRS sample comprises a plurality of extended DMRS samples, a quantity of extended DMRS samples included in the plurality of extended DMRS samples exceeding a predetermined threshold quantity of DMRS samples, and (3) the extrapolating module further applies a windowing function to at least a portion of the plurality of extended DMRS samples prior to extrapolating the frequency edge for the augmented channel estimation signal.

Example 16: The system of any of examples 13-15, wherein (1) the channel estimation signal comprises a left edge DMRS sample and a right edge DMRS sample, (2) the extending module generates the extended channel estimation signal by (A) determining the at least one extended DMRS sample that extends the edge of the channel estimation signal by determining at least one left edge extended DMRS sample that extends the left edge of the channel estimation signal, (B) determining at least one right edge extended DMRS sample that extends the right edge of the channel estimation signal, and (C) extending the edge of the channel estimation signal by including the at least one left edge extended DMRS sample, the plurality of DMRS samples, and the at least one right edge extended DMRS sample as part of the extended channel estimation signal.

Example 17: The system of example 16, wherein the extending module generates the extended channel estimation signal by further (1) designating the at least one left edge extended DMRS sample, the plurality of DMRS samples, and the at least one right edge extended DMRS sample as a first extended channel estimation signal comprising a first extended right edge and a first extended left edge, (2) determining at least one extended intermediate left edge DMRS sample that extends the first extended left edge of the first extended channel estimation signal, (3) determining at least one extended intermediate right edge DMRS sample that extends the first extended right edge of the first extended channel estimation signal, and (4) including the at least one extended intermediate left edge DMRS sample, the first extended channel estimation signal, and the at least one extended intermediate right edge DMRS sample as part of the extended channel estimation signal.

Example 18: A system comprising (1) a fifth-generation new radio base station that receives an uplink signal from a user equipment device, the uplink signal comprising a frequency domain channel estimation signal comprising a plurality of DMRS samples, (2) a channel estimation device comprising (A) a receiving module that receives, as part of a DMRS channel estimation operation, the channel estimation signal comprising the plurality of DMRS samples, (B) an extending module that generates an extended channel estimation signal by (i) determining at least one extended DMRS sample that extends at least one edge of the channel estimation signal based on (a) an edge DMRS sample included in the plurality of DMRS samples at the edge of the channel estimation signal, (b) at least one additional DMRS sample included in the plurality of DMRS samples, (ii) extending the edge of the channel estimation signal by including the plurality of DMRS samples and the at least one extended DMRS sample as part of the extended channel estimation signal, and (C) an extrapolating module that generates an augmented channel estimation signal by extrapolating, based on the extended channel estimation signal, a frequency edge for the augmented channel estimation signal.

Example 19: The system of example 18, wherein the extending module determines the extended DMRS sample by (1) selecting the additional DMRS sample from the plurality of DMRS samples included in the channel estimation signal based on a target frequency interval between the extended DMRS sample and the edge DMRS sample, and (2) determining the extended DMRS sample based on a normalized power spectral density of the edge DMRS sample and a complex conjugate of the additional DMRS sample.

Example 20: The system of any of examples 18-19, wherein (1) the channel estimation signal corresponds to a data packet including a number of resource blocks that exceed a predetermined threshold number of resource blocks, (2) the at least one extended DMRS sample comprises a plurality of extended DMRS samples, a quantity of extended DMRS samples included in the plurality of extended DMRS samples exceeding a predetermined threshold quantity of DMRS samples, and (3) the extrapolating module further applies a windowing function to at least a portion of the plurality of extended DMRS samples prior to extrapolating the frequency edge for the augmented channel estimation signal.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive a frequency domain signal to be transformed, transform the frequency domain signal, output a result of the transformation to perform a channel estimation function, use the result of the transformation to estimate an uplink channel, and store the result of the transformation to maintain or reestablish a connection with a user equipment device via the uplink channel. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, as part of a demodulation reference signal (DMRS) channel estimation operation, a frequency domain channel estimation signal comprising a plurality of DMRS samples;
generating an extended channel estimation signal by:
determining at least one extended DMRS sample that extends at least one edge of the channel estimation signal based on:
an edge DMRS sample included in the plurality of DMRS samples at the edge of the channel estimation signal;
at least one additional DMRS sample included in the plurality of DMRS samples;
extending the edge of the channel estimation signal by including the plurality of DMRS samples and the at least one extended DMRS sample as part of the extended channel estimation signal; and
generating an augmented channel estimation signal by extrapolating, based on the extended channel estimation signal, a frequency edge for the augmented channel estimation signal.

2. The computer-implemented method of claim 1, wherein determining the extended DMRS sample comprises:
selecting the additional DMRS sample from the plurality of DMRS samples included in the channel estimation signal based on a target frequency interval between the extended DMRS sample and the edge DMRS sample; and
determining the extended DMRS sample based on a normalized power spectral density of the edge DMRS sample and a complex conjugate of the additional DMRS sample.

3. The computer-implemented method of claim 1, wherein:
the edge of the channel estimation signal comprises a right edge of the channel estimation signal;
the edge DMRS sample comprises a right edge DMRS sample, the right edge DMRS sample having a higher frequency than other DMRS samples included in the plurality of DMRS samples; and
the additional DMRS sample comprises a DMRS sample included in the plurality of DMRS samples having a lower frequency than the right edge DMRS sample.

4. The computer-implemented method of claim 1, wherein:
the edge of the channel estimation signal comprises a left edge of the channel estimation signal;
the edge DMRS sample comprises a left edge DMRS sample, the left edge DMRS sample having a lower frequency than other DMRS samples included in the plurality of DMRS samples; and
the additional DMRS sample comprises a DMRS sample included in the plurality of DMRS samples having a higher frequency than the left edge DMRS sample.

5. The computer-implemented method of claim 1, wherein:
the channel estimation signal corresponds to a data packet including a number of resource blocks that exceed a predetermined threshold number of resource blocks;
the at least one extended DMRS sample comprises a plurality of extended DMRS samples, a quantity of extended DMRS samples included in the plurality of extended DMRS samples exceeding a predetermined threshold quantity of DMRS samples; and
the computer-implemented method further comprises applying a windowing function to at least a portion of the plurality of extended DMRS samples prior to extrapolating the frequency edge for the augmented channel estimation signal.

6. The computer-implemented method of claim 5, wherein at least one of:
the predetermined threshold number of resource blocks is greater than twenty-five resource blocks;
the plurality of extended DMRS samples includes at least sixteen extended DMRS samples; or
the windowing function comprises a raised cosine windowing function.

7. The computer-implemented method of claim 1, wherein:
the channel estimation signal comprises a left edge DMRS sample and a right edge DMRS sample;
generating the extended channel estimation signal further comprises:
determining the at least one extended DMRS sample that extends the edge of the channel estimation signal by determining at least one left edge extended DMRS sample that extends the left edge of the channel estimation signal;
determining at least one right edge extended DMRS sample that extends the right edge of the channel estimation signal; and
extending the edge of the channel estimation signal by including the at least one left edge extended DMRS sample, the plurality of DMRS samples, and the at least one right edge extended DMRS sample as part of the extended channel estimation signal.

8. The computer-implemented method of claim 7, wherein generating the extended channel estimation signal further comprises:
designating the at least one left edge extended DMRS sample, the plurality of DMRS samples, and the at least one right edge extended DMRS sample as a first extended channel estimation signal comprising a first extended right edge and a first extended left edge;
determining at least one extended intermediate left edge DMRS sample that extends the first extended left edge of the first extended channel estimation signal;
determining at least one extended intermediate right edge DMRS sample that extends the first extended right edge of the first extended channel estimation signal; and
extending the edge of the channel estimation signal by including the at least one extended intermediate left edge DMRS sample, the first extended channel estimation signal, and the at least one extended intermediate right edge DMRS sample as part of the extended channel estimation signal.

9. The computer-implemented method of claim 1, wherein extrapolating the frequency edge for the augmented channel estimation signal comprises applying a precalculated interpolation matrix to the edge of the extended channel estimation signal.

10. The computer-implemented method of claim 1, further comprising generating:
a time-domain representation of the augmented channel estimation signal by applying an inverse fast Fourier transform to the augmented channel estimation signal;
a noise-reduced time domain representation of the augmented channel estimation signal by applying a noise reduction filter to the time-domain representation of the augmented channel estimation signal; and
a noise-reduced frequency-domain signal by applying a fast Fourier transform to the noise-reduced time domain representation of the augmented channel estimation signal, the noise-reduced frequency-domain signal comprising a plurality of frequency domain samples in a series of signals having at least one left end sample and at least one right end sample.

11. The computer-implemented method of claim 10, wherein:
the channel estimation operation corresponds to a first DMRS configuration type;
the computer-implemented method further comprises at least one of:
when the channel estimation signal corresponds to a first code division multiplex (CDM) group, moving the at least one right end sample to a first position in the series that precedes the left end sample; or
when the channel estimation signal corresponds to a second CDM group and the at least one right end sample comprises two samples, moving the two samples from the right end of the noise-reduced frequency-domain signal to the first position in the series.

12. The computer-implemented method of claim 10, wherein:
the channel estimation operation corresponds to a second DMRS configuration type;
the computer-implemented method further comprises:
prior to applying the fast Fourier transform to the noise-reduced time domain representation of the augmented channel estimation signal, applying a phase rotation to the noise-reduced time-domain signal;
at least one of:
when the channel estimation signal corresponds to a first code division multiplex (CDM) group and the at least one right end sample comprises two samples, moving the two samples from a right end of the noise-reduced frequency-domain signal to a first position in the series that precedes the left end sample;
when the channel estimation signal corresponds to a second CDM group and the at least one right end sample comprises two samples, moving the two samples from the right end of the noise-reduced frequency-domain signal to the first position; or
when the channel estimation signal corresponds to a third CDM group and the at least one right end sample comprises four samples, moving the four samples from the right end of the noise-reduced frequency-domain signal to the first position.

13. A system comprising:
a receiving module, stored in memory, that receives, as part of a demodulation reference signal (DMRS) channel estimation operation, a frequency domain channel estimation signal comprising a plurality of DMRS samples;
an extending module, stored in memory, that generates an extended channel estimation signal by:
determining at least one extended DMRS sample that extends at least one edge of the channel estimation signal based on:
an edge DMRS sample included in the plurality of DMRS samples at the edge of the channel estimation signal;
at least one additional DMRS sample included in the plurality of DMRS samples;
extending the edge of the channel estimation signal by including the plurality of DMRS samples and the at least one extended DMRS sample as part of the extended channel estimation signal;
an extrapolating module, stored in memory, that generates an augmented channel estimation signal by extrapolating, based on the extended channel estimation signal, a frequency edge for the augmented channel estimation signal; and
at least one physical processor that executes the receiving module, the extending module, and the extrapolating module.

14. The system of claim 13, wherein the extending module determines the extended DMRS sample by:
selecting the additional DMRS sample from the plurality of DMRS samples included in the channel estimation signal based on a target frequency interval between the extended DMRS sample and the edge DMRS sample; and
determining the extended DMRS sample based on a normalized power spectral density of the edge DMRS sample and a complex conjugate of the additional DMRS sample.

15. The system of claim 13, wherein:
the channel estimation signal corresponds to a data packet including a number of resource blocks that exceed a predetermined threshold number of resource blocks;
the at least one extended DMRS sample comprises a plurality of extended DMRS samples, a quantity of extended DMRS samples included in the plurality of extended DMRS samples exceeding a predetermined threshold quantity of DMRS samples; and
the extrapolating module further applies a windowing function to at least a portion of the plurality of extended DMRS samples prior to extrapolating the frequency edge for the augmented channel estimation signal.

16. The system of claim 13, wherein:
the channel estimation signal comprises a left edge DMRS sample and a right edge DMRS sample;
the extending module generates the extended channel estimation signal by:
determining the at least one extended DMRS sample that extends the edge of the channel estimation signal by determining at least one left edge extended DMRS sample that extends the left edge of the channel estimation signal;
determining at least one right edge extended DMRS sample that extends the right edge of the channel estimation signal; and
extending the edge of the channel estimation signal by including the at least one left edge extended DMRS sample, the plurality of DMRS samples, and the at least one right edge extended DMRS sample as part of the extended channel estimation signal.

17. The system of claim 16, wherein the extending module generates the extended channel estimation signal by further:
designating the at least one left edge extended DMRS sample, the plurality of DMRS samples, and the at least one right edge extended DMRS sample as a first extended channel estimation signal comprising a first extended right edge and a first extended left edge;
determining at least one extended intermediate left edge DMRS sample that extends the first extended left edge of the first extended channel estimation signal;
determining at least one extended intermediate right edge DMRS sample that extends the first extended right edge of the first extended channel estimation signal; and
including the at least one extended intermediate left edge DMRS sample, the first extended channel estimation signal, and the at least one extended intermediate right edge DMRS sample as part of the extended channel estimation signal.

18. A system comprising:
a fifth-generation new radio base station that receives an uplink signal from a user equipment device, the uplink signal comprising a frequency domain channel estimation signal comprising a plurality of demodulation reference signal (DMRS) samples;
a channel estimation device comprising:
a receiving module that receives, as part of a DMRS channel estimation operation, the channel estimation signal comprising the plurality of DMRS samples;
an extending module that generates an extended channel estimation signal by:
determining at least one extended DMRS sample that extends at least one edge of the channel estimation signal based on:
an edge DMRS sample included in the plurality of DMRS samples at the edge of the channel estimation signal;
at least one additional DMRS sample included in the plurality of DMRS samples;
extending the edge of the channel estimation signal by including the plurality of DMRS samples and the at least one extended DMRS sample as part of the extended channel estimation signal; and
an extrapolating module that generates an augmented channel estimation signal by extrapolating, based on the extended channel estimation signal, a frequency edge for the augmented channel estimation signal.

19. The system of claim 18, wherein the extending module determines the extended DMRS sample by:
selecting the additional DMRS sample from the plurality of DMRS samples included in the channel estimation signal based on a target frequency interval between the extended DMRS sample and the edge DMRS sample; and
determining the extended DMRS sample based on a normalized power spectral density of the edge DMRS sample and a complex conjugate of the additional DMRS sample.

20. The system of claim 18, wherein:
the channel estimation signal corresponds to a data packet including a number of resource blocks that exceed a predetermined threshold number of resource blocks;
the at least one extended DMRS sample comprises a plurality of extended DMRS samples, a quantity of extended DMRS samples included in the plurality of extended DMRS samples exceeding a predetermined threshold quantity of DMRS samples; and
the extrapolating module further applies a windowing function to at least a portion of the plurality of extended DMRS samples prior to extrapolating the frequency edge for the augmented channel estimation signal.
